(19) United States
(12) Patent Application Publication
(10) Pub. No.: US 2017/0368628 A1
(43) Pub. Date: Dec. 28, 2017

(54) SPRAY APPARATUS AND METHOD OF EJECTING MIST USING SPRAY APPARATUS

(71) Applicant: Fujitsu Ten Limited, Kobe-shi (JP)

(72) Inventors: Hisaki Hayashi, Kobe-shi (JP); Yasuyuki Watanabe, Kobe-shi (JP)

(21) Appl. No.: 15/616,610

(22) Filed: Jun. 7, 2017

(30) Foreign Application Priority Data
Jun. 23, 2016 (JP) 2016-125009

(51) Int. Cl. B23K 3/08; B05B 1/28

(52) U.S. Cl. CPC B23K 3/082; B05B 1/28

(57) ABSTRACT

There is provided a spray apparatus. A first nozzle is configured to eject mist. A second nozzle is provided around the first nozzle. The second nozzle is configured to suck a part of the mist ejected from the first nozzle and to eject a remnant of the mist to an ejection target.

### CROSS-REFERENCE TO RELATED APPLICATIONS

This application is based on and claims priority from Japanese Patent Application No. 2016-125009 filed on Jun. 23, 2016.

### TECHNICAL FIELD

The disclosure relates to a spray apparatus and a method of ejecting mist by using the spray apparatus.

### RELATED ART

In the related art, a soldering has been widely used as a method of bonding metal components such as lands and through-holes formed on a surface of a printed board and lead lines of mounted components such as a semiconductor device and a capacitor mounted on the board so that energization can be enabled. As a pre-process of the soldering, it is necessary to apply a flux solution. In general, the flux solution is a liquid in which a rosin-based or acryl-based resin, an alcohol or aromatic solvent and an activator are mixed. The flux solution is uniformly applied to places in advance, at which the metal components and the mounted components are to be bonded by the soldering, on the printed board, so that an oxide layer formed on the target places becomes reduced or removed. As a result, a clean adhesion surface is formed at the target places, wettability between the soldering and the metal surface is improved and the bonding becomes strong.

In order to uniformly apply the flux solution to the applying target, a method of ejecting the flux solution in a mist form by using a spray has been widely used. In general, the spray is configured to eject compressed liquid from an ejection port (orifice) of a nozzle tip and to form the liquid into fine particles, thereby ejecting the mist.

Meanwhile, in order to eject the liquid in the mist form, a pressure (ejection pressure) by which the liquid is to be introduced into the nozzle should be a predetermined pressure or higher. If the ejection pressure is lower than the predetermined pressure, the liquid is ejected from the nozzle without being formed into the mist. A flying distance (reaching distance) and a spreading angle (ejection angle) of the mist to be ejected from the ejection port depend on the ejection pressure, so that they increase as the ejection pressure increases. Therefore, in general, when ejecting the flux by using the spray, it is difficult to make the reaching distance and ejection angle of the flux solution to be ejected smaller than predetermined values.

However, when ejecting and applying the flux to the through-holes of the board by using the spray, the reaching distance becomes long, so that the flux may pass through the through-holes, which are the applying target, and may be unintentionally attached to the components on the board. Also, the ejection angle becomes large, so that the flux may be unintentionally attached to the mounted components, which are not the applying target. In this case, in a rotary encoder to be used for a dial for volume adjustment of an audio product, for example, the flux may be introduced into a component, so that a malfunction may be caused. In the meantime, as a method of feebly applying a small amount of flux, a method of using an ultrasonic flux spray apparatus has been known. However, the corresponding apparatus has a complicated structure and is expensive.

Therefore, as a method of uniformly applying a necessary amount of flux into the through-holes of the printed board without using the spray, a method of using a flux applying apparatus of Patent Document 1 has been known, for example. The flux applying apparatus disclosed in Patent Document 1 is configured to jet a flux reserved in a nozzle from an upward opening and to bring a liquid surface of the jetted flux into contact with the board, thereby applying the flux to the board.

Patent Document 1: Japanese Patent Application Publication No. 2005-262247A

According to the flux applying apparatus disclosed in Patent Document 1, it is possible to apply the flux to the through-holes by a suction effect of the surface tension without introducing the flux into the component. However, with the flux applying apparatus disclosed in Patent Document 1, it is not possible to control an attachment amount of the flux into the through-holes and the flux is attached beyond necessity. For this reason, a surplus flux accumulated in the through-holes is pushed by the soldering upon the soldering, so that the flux is likely to be introduced into the component. Also, when drying and removing the surplus flux accumulated in the through-holes, it takes time until the drying is completed, which may lower the productivity. Also, the flux applying apparatus has demerits that a structure thereof is complex and a failure risk is high.

### SUMMARY

It is therefore an object of the present invention to provide a spray technology capable of reducing an amount and a flow strength of mist to be ejected and favorably spraying the mist to an ejection target.

According to an aspect of the embodiments of the present invention there is provided a spray apparatus comprising: a first nozzle configured to eject mist; and a second nozzle provided around the first nozzle, wherein the second nozzle is configured to suck a part of the mist ejected from the first nozzle and to eject a remnant of the mist to an ejection target.

According to the disclosure, the first nozzle configured to eject the mist is provided with the second nozzle, and a part of the mist ejected from the first nozzle is sucked by the second nozzle. For this reason, a flow rate and an ejection pressure of the mist to be ejected to the ejection target are reduced.

According to the disclosure, it is possible to reduce the amount and flow strength of the mist to be ejected by the structure simpler than the related art and to spray the flux to a part or a component, for which the spray apparatus of the related art cannot be used.

### BRIEF DESCRIPTION OF THE DRAWINGS

Exemplary embodiments of the present invention will be described in detailed based on the following figures, wherein:

FIG. 1 illustrates an overall flux spray apparatus in accordance with a first illustrative embodiment;

FIG. 2 illustrates a nozzle device in accordance with the first illustrative embodiment;

FIG. 3 illustrates the nozzle device when a flux is applied to a target by using a flux spray apparatus of the related art;

FIG. 4 illustrates the nozzle device when the flux is applied to the target by using the flux spray apparatus of the first illustrative embodiment;

FIG. 5 depicts a nozzle device in a flux spray apparatus in accordance with a second illustrative embodiment, in which (a) is a perspective view of the nozzle device and (b) illustrates the nozzle device when the flux is applied to the target; and

FIG. 6 is a graph depicting a comparison test result of flux spray apparatuses of an embodiment and a conventional example.

### DETAILED DESCRIPTION

Hereinafter, favorable illustrative embodiments of the disclosure will be described with reference to the drawings. The illustrative embodiments to be described later are just examples for implementing the disclosure, and the disclosure is not limited to the illustrative embodiments.

### First Illustrative Embodiment

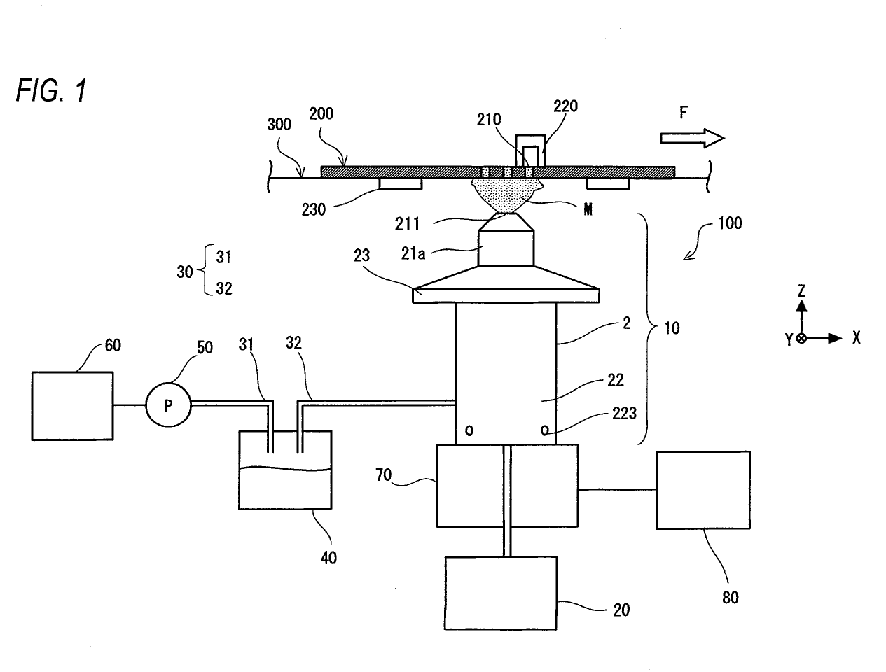

An outline of a flux spray apparatus 100 in accordance with a first illustrative embodiment is described with reference to FIG. 1. FIG. 1 depicts the overall flux spray apparatus 100 in accordance with the first illustrative embodiment. In FIG. 1, a direction from left towards right is an X direction, a direction from a front side of the drawing sheet towards an inner side thereof is a Y direction, and a direction from below towards above is a Z direction. A −Z direction coincides with a perpendicular direction. As shown in FIG. 1, the flux spray apparatus 100 includes a nozzle device 10, a flux solution supply device 20, a negative pressure pipe 30 including a first negative pressure pipe 31 and a second negative pressure pipe 32, a flux solution collection device 40, a negative pressure generation device 50, a negative pressure control device 60, a base 70, and a movement device 80. The nozzle device 10 is set on the base 70, and the base 70 is coupled to the movement device 80 with the nozzle device 10 being set thereon. The nozzle device 10 is configured to communicate with the flux solution supply device 20 via the base 70. Also, the nozzle device 10 is configured to communicate with the flux solution collection device 40 via the second negative pressure pipe 32. The flux solution collection device 40 is further configured to communicate with the negative pressure generation device 50 via the first negative pressure pipe 31. The negative pressure generation device 50 is connected with the negative pressure control device 60.

In the first illustrative embodiment, the flux spray apparatus 100 is configured to eject a mist flux M to an outside of the flux spray apparatus 100. When applying the mist flux M to a printed board 200 by using the flux spray apparatus 100, the printed board 200, which is an applying target of the flux, is arranged in the Z direction of the flux spray apparatus 100. That is, the nozzle device 10 is set on the base 70 so that the mist flux M is to be ejected in the Z direction. The base 70 is coupled with the movement device 80, and the nozzle device 10 is configured to be freely moveable on a horizontal plane of the base 70. That is, the nozzle device 10 is configured to be freely moveable on an XY plane.

The printed board 200 is arranged so that a lower surface thereof faces towards the -Z direction, i.e., a perpendicular direction, and is carried in the X direction by a conveyor apparatus 300 with both ends being supported. Then, an operation of applying the flux to the printed board 200 is performed at a predetermined position by the nozzle device 10. The printed board 200 has a plurality of through-holes 210, which are an applying target of the flux. Also, an upper surface of the printed board 200 is provided with an upper surface component 220, which is not an applying target of the flux, and a lower surface of the printed board 200 is provided with a lower surface component 230, which is not an applying target of the flux.

In the flux spray apparatus 100, a driving timing of the movement device 80, an ejection timing of the mist flux M and the like are beforehand programmed in a spray control unit (not shown). Therefore, it is possible to apply the mist flux M from the lower surface of the printed board 200 to an applying target located in a desired region. When the applying of the mist flux M is over, the printed board 200 is sent to a next process and a mounted component is soldered to a part to which the mist flux M has been applied.

Although described in detail later, the flux spray apparatus 100 of the first illustrative embodiment is configured to primarily eject the mist flux M into the nozzle device 10 by mixing a liquid flux L and air supplied to the nozzle device 10 from the flux solution supply device 20. The flux spray apparatus 100 is further configured to generate a negative pressure in the nozzle device 10 by the negative pressure generation device 50, to suck a part of the primarily ejected mist flux M from the inside of the nozzle device 10, and to secondarily eject the remnant from the nozzle device 10 to the applying target. As a result, it is possible to reduce an ejection amount of the mist flux M to be secondarily ejected to the applying target, as compared to an ejection amount of the mist flux M to be primarily ejected into the nozzle device 10. Also, the flux spray apparatus 100 can lower an ejection pressure of the mist flux M to be secondarily ejected by enabling the negative pressure to act in the nozzle device 10. As a result, it is possible to shorten a reaching distance of the mist flux M to be ejected to the applying target and to make an ejection angle smaller.

The flux spray apparatus 100 of the first illustrative embodiment can adjust a flow rate and the ejection pressure of the mist flux M by adjusting the negative pressure, which is to be generated by the negative pressure generation device 50.

In the specification, the term “primary ejection” indicates an ejection in the nozzle device 10 and the term “secondary ejection” indicates an ejection to the outside of the nozzle device 10. The term “flow rate” indicates an amount of fluid to flow per unit time. The term “ejection amount” indicates an amount of the fluid to be ejected. The term “ejection pressure” is an index indicative of flow strength of the fluid to be ejected, and indicates a pressure of the fluid in the nozzle upon ejection of the fluid from an ejection port of the spray nozzle. The term “reaching distance” is a flying distance of the fluid to be ejected, and indicates a straight line distance up to the farthest position, which the fluid can reach from the ejection port, on a central axis of the ejection port. The term “ejection angle” indicates a spreading angle of the fluid ejected from the spray nozzle. Also, the term “negative pressure” indicates is a pressure of the fluid in any space and indicates a pressure lower than an outside of the space. The negative pressure indicates a negative value. The larger an absolute value of the negative pressure, a pressure is lower. In the below, the respective configurations are described with reference to FIG. 1.

The flux solution supply device 20 is a device configured to supply the liquid flux L to the nozzle device 10 and to apply an ejection pressure, which is necessary to generate the mist flux M from the liquid flux L, to the mist flux M. The flux solution supply device 20 has an air compressor embedded therein, and is configured to supply the air compressed together with the compressed liquid flux L to the nozzle device 10. The compressed liquid flux L and the compressed air are mixed by the nozzle device 10, so that the mist flux M is obtained. In the first illustrative embodiment, the configuration of the flux solution supply device 20 is not particularly limited and can be appropriately changed.

The negative pressure generation device 50 is a device configured to operate all the time or temporarily, thereby generating a negative pressure in the nozzle device 10. The negative pressure generation device 50 is configured to communicate with the inside of the nozzle device 10 via the negative pressure pipe 30 and the flux solution collection device 40. For this reason, when the negative pressure generation device 50 is operated, the negative pressure acts in the nozzle device 10 and a part of the mist flux M is sucked from the inside of the nozzle device 10. The negative pressure generation device 50 can adjust the negative pressure acting in the nozzle device 10 within a predetermined range. In order to operate the negative pressure generation device 50, an operator may manually operate the same or control the same in a program manner by the negative pressure control device 60. As the negative pressure generation device 50, a pump may be exemplified. The negative pressure generation device 50 corresponds to the suction device of the disclosure.

The flux solution collection device 40 is a device configured to separate the mist flux M sucked from the nozzle device 10 into the liquid flux L and the air and to reserve therein the separated liquid flux L. The flux solution collection device 40 is configured to communicate with the negative pressure pipe 30 configured to communicate the nozzle device 10 and the negative pressure generation device 50 each other. More specifically, the flux solution collection device 40 is configured to communicate with the negative pressure generation device 50 via the first negative pressure pipe 31 and to communicate with the nozzle device 10 via the second negative pressure pipe 32. The mist flux M sucked from the inside of the nozzle device 10 as the negative pressure generation device 50 operates is collected to the flux solution collection device 40 via the second negative pressure pipe 32. The mist flux M collected to the flux solution collection device 40 is separated into the liquid flux L and the air, and the liquid flux L is reserved in the flux solution collection device 40. As a method of separating the liquid flux L from the mist flux M, a method of using a mist separator may be used, for example.

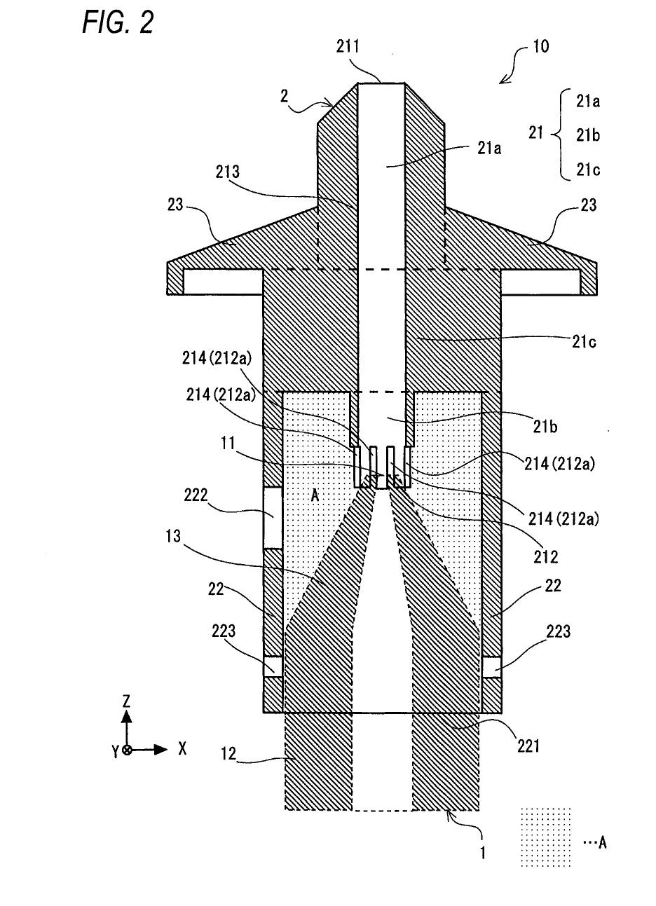

Subsequently, the nozzle device 10 provided for the flux spray apparatus 100 is described with reference to FIG. 2. FIG. 2 depicts the nozzle device 10 of the first illustrative embodiment.

As shown in FIG. 2, the nozzle device 10 of the first illustrative embodiment has a first nozzle 1 and a second nozzle 2 externally fitted to the first nozzle 1. The first nozzle 1 is a nozzle configured to communicate with the flux solution supply device 20 via the base 70, to generate the mist flux M and to primarily eject the mist flux M into the nozzle device 10. Also, the second nozzle 2 is a nozzle configured to suck/discharge a part of the mist flux M primarily ejected by the first nozzle 1 from the inside of the nozzle device 10 and to secondarily eject the remaining mist flux M to an exterior air, thereby ejecting the mist flux M to the applying target.

The first nozzle 1 is generally a nozzle for spray to be used for applying the flux. That is, the first nozzle 1 has a straight cylinder part 12 connected in communication with to the base 70, a tapered part 13 coaxially connected with the straight cylinder part 12 and a first ejection port 11 having a circular shape and provided at a tip of the tapered part 13. The straight cylinder part 12, the tapered part 13 and the first ejection port 11 are configured to communicate each other. The straight cylinder part 12 has a cylindrical shape having a predetermined diameter and the tapered part 13 has a substantially conical shape of which an outer diameter gradually decreases towards the first ejection port 11.

The liquid flux L and the air supplied with being compressed from the flux solution supply device 20 are sent from the straight cylinder part 12 via the base 70, are mixed while passing an inside of the tapered part 13 and are ejected with a predetermined ejection pressure P, so that the mist flux M of a flow rate F is generated. The mist flux M is primarily ejected from the first ejection port 11 into the nozzle device 10. In the first illustrative embodiment, the structure of the first nozzle 1 is not particularly limited and can be appropriately changed.

Subsequently, the second nozzle 2 is described in detail. The second nozzle 2 can be generally externally fitted to the first nozzle 1, which is a nozzle for spray to be used for applying the flux, and is formed to be fixable to the first nozzle 1. Therefore, the second nozzle 2 has a function as an attachment configured to be detachably mounted to the existing nozzle. As shown with a broken line in FIG. 2, the second nozzle 2 has a cylindrical main body part 21 having a predetermined inner diameter and different outer diameters in an axial direction, a cylindrical housing part 22 formed around the main body part, and a collar part 23.

As shown with the broken line in FIG. 2, the main body part 21 has an ejection portion 21a located at one end portion-side, an introduction portion 21b located at the other end portion-side, and a large-diameter portion 21c formed between the ejection portion 21a and the introduction portion 21b and having an outer diameter greater than an outer diameter of the introduction portion 21b. The ejection portion 21a, the introduction portion 21b and the large-diameter portion 21c are formed so that central axes thereof coincide each other. A tip of the ejection portion 21a is provided with a second ejection port 211 configured to secondarily eject the mist flux M to the applying target, and a tip of the introduction portion 21b is provided with an introduction port 212 configured to introduce the mist flux M primarily ejected from the first ejection port 11 of the first nozzle 1 into the second nozzle 2. The second ejection port 211 and the introduction port 212 have circular shapes of the same diameter, and centers of the second ejection port 211 and the introduction port 212 are located on the central axis of the main body part 21. Also, the main body part 21 is formed with a communication path 213 configured to communicate with the second ejection port 211 and the introduction port 212 and to axially penetrate the second nozzle 2.

The ejection portion 21a of the main body part 21 has a taper shape of which an apex is the second ejection port 211, so as to easily remove the dripped flux ejected from the second ejection port 211.

Diameters of the introduction port 212 and the communication path 213 are smaller than an outer diameter of the straight cylinder part 12 of the first nozzle 1 and greater than an outer diameter of the tip of the tapered part 13 of the first nozzle 1. That is, the diameters of the introduction port 212 and the communication path 213 are greater than a diameter of the first ejection port 11. Also, a peripheral edge portion of the introduction port 212 is formed with a plurality of notches 212a equidistantly spaced over an entire circumference in a circumferential direction.

A peripheral edge of an end surface of the large-diameter portion 21c, which is located at the introduction portion 21b-side, is formed with the cylindrical housing part 22 coaxially with the main body part 21. That is, an inner diameter of the housing part 22 is greater than the outer diameter of the introduction portion 21b. Also, the inner diameter of the housing part 22 is set to a size greater than the outer diameter of the straight cylinder part 12 of the first nozzle 1 by about a fitting tolerance so that it can be externally fitted to the first nozzle 1. Herein, the inner diameter of the housing part 22 is preferably twice as large as the outer diameter of the introduction portion 21b. In the second nozzle 2 of the first illustrative embodiment, the outer diameter of the introduction portion 21b is 8 mm, and the inner diameter of the housing part 22 is 24 mm.

Also, an opening end 221, which is an axial tip of the housing part 22, more protrudes axially than the introduction portion 21b of the main body part 21. That is, the second nozzle 2 has a double cylindrical shape of the cylindrical main body part 21 and the cylindrical housing part 22, in which the introduction portion 21b of the main body part 21, which is an inner cylindrical member, is positioned in the second nozzle 2 at an axially more inner side than the opening end 221 of the housing part 22, which is an outer cylindrical member.

A sidewall of the housing part 22 is connected with the negative pressure pipe 30 configured to communicate the flux solution collection device 40 and the inside of the nozzle device 10, and is formed with a penetrated suction port 222 through which the mist flux M is to be discharged. The suction port 222 is configured so that a suction nozzle E can be screwed therein. The negative pressure pipe 30 is connected to the suction port 222 via the suction nozzle E.

Also, the housing part 22 is provided with a plurality of screw holes 223 with a predetermined interval in the circumferential direction into which screws B (not shown) are to be screwed so as to fix the first nozzle 1 to the second nozzle 2. The screw holes 223 are located at the opening end 221-side axially closer than the suction port 222.

The collar part 23 is formed to extend around the ejection portion 21a of the main body part 21. The collar part 23 has a circular shape of which a section perpendicular to the central axis of the main body part 21 has a center on the axis of the main body part 21. Also, the section of the collar part 23, including the central axis of the main body part 21, has a taper shape of which a width gradually decreases towards the ejection portion 21a. For this reason, it is possible to easily remove the flux dripped from the second ejection port 211 and the dripped flux rebounded from the printed board 200. An outer diameter of the collar part 23 at the large-diameter portion 21c-side is about twice as large as the outer diameter of the housing part 22.

In order to assemble the nozzle device 10 of the first illustrative embodiment, the second nozzle 2 is externally fitted to the first nozzle 1 from the opening end 221 along the central axis of the communication path 213 at a state where the first ejection port 11 and the introduction port 212 are concentric with each other and face each other.

Since the inner diameter of the housing part 22 is greater than the outer diameter of the straight cylinder part 12 of the first nozzle 1 by the fitting tolerance, the housing part 22 does not inhibit that the straight cylinder part 12 of the first nozzle 1 is to be inserted into the second nozzle 2. For this reason, the straight cylinder part 12 of the first nozzle 1 slides along an inner surface of the housing part 22. As a result, the first nozzle 1 can be inserted up to a position at which the tapered part 13 contacts the introduction portion 21b of the second nozzle 2.

Since a diameter of the introduction port 212 is formed to be smaller than the outer diameter of the straight cylinder part 12 of the first nozzle 1 and to be greater than the outer diameter of the tip of the tapered part 13, the introduction port 212 contacts an outer surface of the tapered part 13 of the first nozzle 1. Therefore, the first ejection port 11 of the first nozzle 1 is located in the introduction portion 21b of the main body part 21 of the second nozzle 2 and in the introduction port 212.

At the state where the introduction port 212 of the second nozzle 2 contacts the outer surface of the tapered part 13 of the first nozzle 1, the inner surface of the housing part 22 contacts the outer surface of the straight cylinder part 12. At this time, the inner surface of the housing part 22 axially contacts the outer surface of the straight cylinder part 12 at the positions at which the screw holes 223 are provided and does not contact the outer surface of the straight cylinder part 12 at the position at which the suction port 222 is provided. At this state, when the screws B (not shown) are tightened from the screw holes 223, the first nozzle 1 and the second nozzle 2 are fixed by the straight cylinder part 12 and the housing part 22. In this way, the second nozzle 2 is externally fitted and fixed to the first nozzle 1, so that the nozzle device 10 is assembled.

At this time, since the peripheral edge portion of the introduction port 212 is formed with the plurality of notches 212a equidistantly spaced over the entire circumference, the contact part between the introduction port 212 of the second nozzle 2 and the outer surface of the tapered part 13 of the first nozzle 1 is formed with a plurality of discharge ports 214 by a surface forming the plurality of notches 212a and the outer surface of the tapered part 13. That is, the discharge ports 214 are formed in the communication path 213 in the vicinity of the first ejection port 11 of the first nozzle 1. Also, since the plurality of notches 212a has the same shape, the plurality of discharge ports 214 also has the same shape.

Also, in the nozzle device 10, a space A surrounded by the tapered part 13 of the first nozzle 1, the housing part 22 of the second nozzle 2, the introduction portion 21b and the large-diameter portion 21c is formed. Since the outer surface of the straight cylinder part 12 and the inner surface of the housing part 22 contact each other, the space A communicates with the outside of the nozzle device 10 only at the suction port 222 and the discharge ports 214.

The nozzle device 10 assembled as described above is set on the base 70 so that the second ejection port 211 of the main body part 21 of the second nozzle 2 faces towards the Z direction.

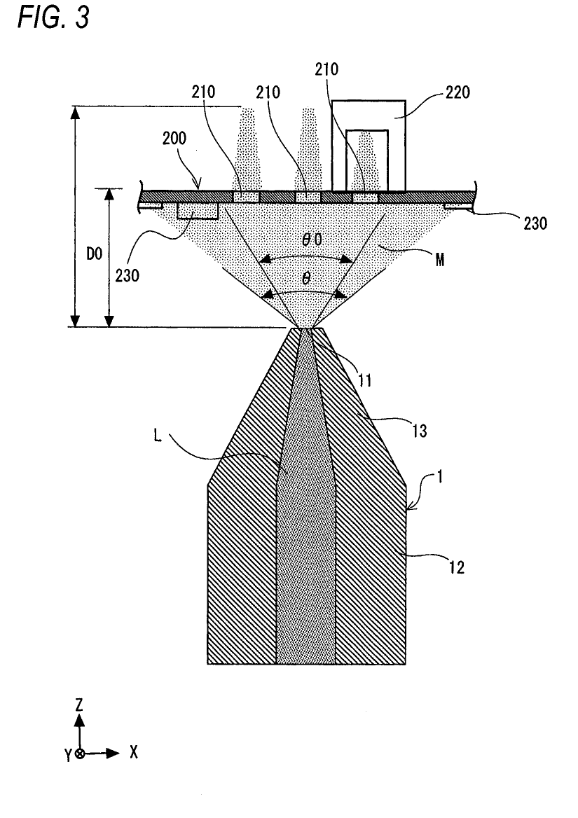

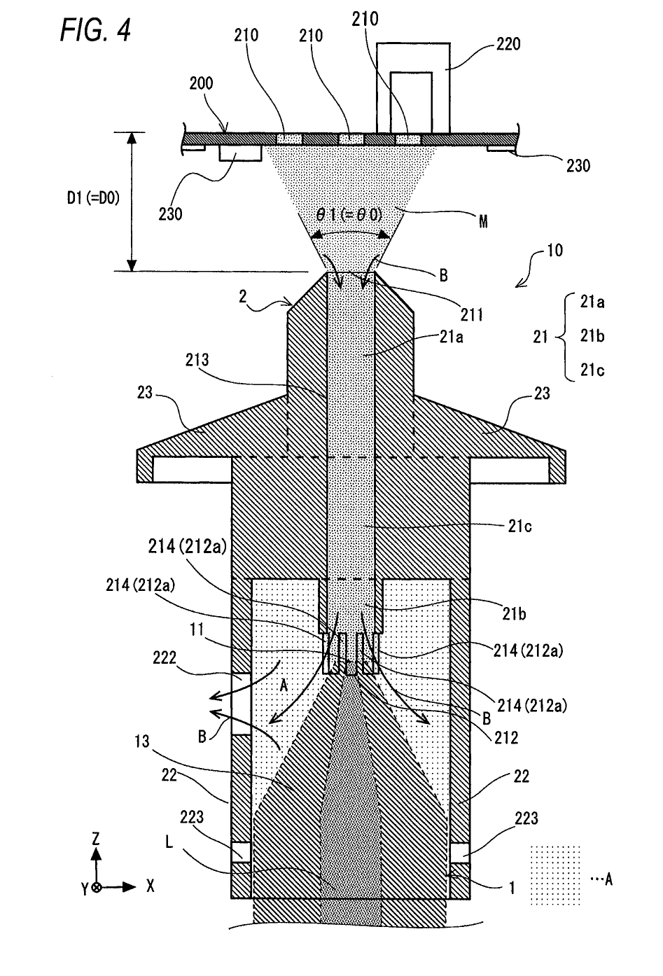

In the below, a series of operations of applying the mist flux M to the through-holes 210 formed in the printed board 200 by using the flux spray apparatus 100 of the first illustrative embodiment are described with reference to FIGS. 3 and 4.

FIG. 3 illustrates the nozzle device 10 when the mist flux M is applied to the through-holes 210 formed in the printed board 200 by using a flux spray apparatus 100a of the related art, as a comparative example. FIG. 4 illustrates the nozzle device 10 when the mist flux M is applied to the through-holes 210 formed in the printed board 200 by using the flux spray apparatus 100 of the first illustrative embodiment.

In order to favorably apply the mist flux M to the through-holes 210 formed in the printed board 200, it is preferable that the mist flux M is applied to the entire inner surfaces of the through-holes 210 and the mist flux M does not pass through the through-holes 210. That is, a reaching distance of the mist flux M to be secondarily ejected is preferably a favorable reaching distance D0, which is a distance from the ejection port, from which the mist flux M is to be secondarily ejected, to an upper surface of the printed board.

Also, in order to favorably apply the mist flux M to the through-holes 210, it is preferable that the secondarily ejected mist flux M is applied to the through-holes 210 and is not applied to the lower surface component 230 arranged on the lower surface of the printed board 200. That is, an ejection angle of the mist flux M to be secondarily ejected is preferably equal to or less than an ejection angle θ0, which is a maximum angle at which the mist flux M is to be applied to the through-holes 210 and is not to be applied to the lower surface component 230.

First, a case where the flux spray apparatus 100a of the related art is used is described with reference to FIG. 3. The flux spray apparatus 100a of the related art is different from the flux spray apparatus 100 of the first illustrative embodiment, in that it does not have the second nozzle 2. That is, as shown in FIG. 3, according to the flux spray apparatus 100a of the related art, the mist flux M is directly ejected from the first nozzle 1 to the applying target. For this reason, the mist flux M is directly ejected to the applying target without being collected to the flux solution collection device 40. In the below, the description of the same configurations as the first illustrative embodiment is omitted.

In the flux spray apparatus 100a, the liquid flux L and the air supplied with being compressed from the flux solution supply device 20 are mixed in the first nozzle 1 and are then ejected with an ejection pressure equal to or higher than a predetermined ejection pressure P, so that the mist flux M of a flow rate F is made. When the ejection is performed with the ejection pressure P, the mist flux M is ejected at a predetermined ejection angle θ from the first ejection port 11 to the applying target. At this time, a reaching distance of the mist flux becomes a predetermined reaching distance D. When the ejection pressure is higher than the predetermined ejection pressure P, the reaching distance becomes longer than the predetermined reaching distance D and the ejection angle becomes greater than the predetermined ejection angle θ. Herein, in order to form the liquid flux L into the mist flux M, it is necessary to eject the mist flux M with a pressure equal to or higher than the predetermined ejection pressure P. Therefore, it is not possible to make the reaching distance shorter than the predetermined reaching distance D and the ejection angle smaller than the predetermined ejection angle θ.

As shown in FIG. 3, when the predetermined reaching distance D is longer than the favorable reaching distance D0, the surplus mist flux M passes through the through-holes 210, which are the applying target, so that the surplus mist flux may be unintentionally attached to the upper surface component 220 on the printed board 200. Also, when the predetermined ejection angle θ is greater than the favorable ejection angle θ0, the surplus mist flux M spread in a wider range than a region intended to be applied may be unintentionally attached to the lower surface component 230, which is not the applying target. Also, when the flow rate F of the ejected mist flux M is high, the surplus flux may be attached to the inner surfaces of the through-holes 210.

Subsequently, a case where the flux spray apparatus 100 of the first illustrative embodiment is used is described with reference to FIG. 4. As described above, according to the flux spray apparatus 100, the second nozzle 2 is externally fitted to the first nozzle 1 in the nozzle device 10, so that the space A and the plurality of discharge ports 214 are formed. In the space A, the suction port 222 is configured to communicate with the negative pressure generation device 50 via the negative pressure pipe 30 and the flux solution collection device 40, and the discharge ports 214 are configured to communicate with the outside via the communication path 213.

The flux spray apparatus 100 of the first illustrative embodiment is configured to generate the mist flux M by the first nozzle 1 and to once eject the generated mist flux M into the nozzle device 10. More specifically, the liquid flux L supplied from the flux solution supply device 20 is mixed with the air in the first nozzle 1, so that it becomes the mist flux M of a flow rate F1 and is then primarily ejected from the first ejection port 11 with an ejection pressure P1. The flow rate F1 is the same as the flow rate F, and the ejection pressure P1 is the same as the predetermined ejection pressure P. As shown in FIG. 4, since the first ejection port 11 is located in the introduction port 212 of the second nozzle 2, i.e., the first ejection port 11 is located in the communication path 213, the mist flux M is primarily ejected into the communication path 213.

When the negative pressure generation device 50 is operating with the mist flux M being primarily ejected into the introduction portion 21b, the negative pressure acts in the space A because the negative pressure generation device 50 communicates with the space A in the nozzle device 10 via the negative pressure pipe 30 and the flux solution collection device 40. Since the space A is configured to communicate with only the communication path 213 except for the suction port 222 via the discharge ports 214, the suction pressure acts so that the fluid in the communication path 213 is to be sucked by the negative pressure acting in the space A. As a result, as shown with an arrow B in FIG. 4, the suction pressure acts in the nozzle device 10 so that an exterior air is to be introduced from the second ejection port 211 and is to be discharged from the suction port 222.

At this time, since the mist flux M is primarily ejected into the communication path 213 from the first ejection port 11 of the first nozzle 1, the suction pressure acts on the mist flux M. A part of the primarily ejected mist flux M passes through the discharge ports 214 provided around the introduction portion 21b and is then sucked into the space A from the communication path 213. The mist flux M sucked into the space A is discharged from the suction port 222 to the outside of the nozzle device 10, passes through the first negative pressure pipe 31 and is then collected to the flux solution collection device 40. The collected mist flux M is separated into the air and the liquid flux L and the liquid flux L is reserved in the flux solution collection device 40.

The mist flux M, which reaches the second ejection port 211 without being sucked into the space A, of the primarily ejected mist flux M is secondarily ejected from the second ejection port 211. The part of the mist flux M is discharged from the discharge ports, so that an amount of the mist flux M to reach the second ejection port 211 becomes smaller than an amount of the mist flux ejected from the first ejection port 11. For this reason, a flow rate F2 of the mist flux M to be secondarily ejected becomes less than the flow rate F1 of the primarily ejected mist flux M.

Also, the suction pressure acting on the mist flux M in the communication path 213 by the negative pressure in the space A acts so that an ejection pressure of the secondary ejection is to be weakened. For this reason, an ejection pressure P2 of the secondary ejection is lower than the ejection pressure P1 upon the primary ejection.

Herein, the discharge ports 214 are formed with being equidistantly spaced over the entire circumference in the circumferential direction of the communication path 213, and the space A communicates with the communication path 213 via all the discharge ports 214. For this reason, the primarily ejected mist flux M is uniformly sucked from the plurality of discharge ports 214. As a result, the mist flux M to be secondarily ejected forms a uniform spray pattern and is uniformly applied to the applying target. Also, the second nozzle 2 of the first illustrative embodiment is configured so that the inner diameter of the housing part 22 is about twice as large as the outer diameter of the introduction portion 21b having the discharge ports. For this reason, the mist flux M is sucked from the plurality of discharge ports 214 in a balanced manner. As a result, the mist flux M to be secondarily ejected more uniformly forms a uniform spray pattern.

In this way, the flux spray apparatus 100 can operate the negative pressure generation device 50, thereby making the flow rate F2 and ejection pressure P2 of the mist flux M to be secondarily ejected from the second ejection port less than the flow rate F1 and ejection pressure P1 of the mist flux M to be primarily ejected from the first ejection port 11. In other words, it is possible to weaken the secondary ejection, as compared to the primary ejection. That is, the flux spray apparatus 100 can generate the negative pressure in the nozzle device 10 by operating the negative pressure generation device 50, thereby making the flow rate F2 and ejection pressure P2 of the mist flux M to be secondarily ejected less than the flow rate F and ejection pressure P of the mist flux M to be ejected in the flux spray apparatus 100a of the related art. As a result, the flux spray apparatus 100 can make the reaching distance D1 and ejection angle θ1 of the mist flux M to be secondarily ejected smaller than the reaching distance D and ejection angle θ of the mist flux M to be ejected in the flux spray apparatus 100a of the related art.

The flux spray apparatus 100 of the first illustrative embodiment can appropriately adjust a magnitude of the negative pressure that is to act in the space A in the nozzle device 10 by the negative pressure generation device 50. The negative pressure may be adjusted by manually operating the negative pressure generation device 50 or program-controlling the same with the negative pressure control device 60. When the negative pressure having a greater absolute value is enabled to act, the suction pressure to act on the mist flux M also increases and the flow rate F2 and ejection pressure P2 of the mist flux M to be secondarily ejected more decrease. Also, when the absolute value of the negative pressure is made to gradually decrease, the suction pressure to act on the mist flux M also decreases and the flow rate F2 and ejection pressure P2 of the mist flux M to be ejected increase up to the flow rate F1 (≈the flow rate F) and ejection pressure P1 (≈the ejection pressure P) upon the primary ejection, which are upper limits. In this way, the acting negative pressure is controlled by the negative pressure generation device 50, so that the flow rate F2 and the ejection pressure P2 can be adjusted and the reaching distance D1 and the ejection angle θ1 can also be favorably adjusted.

As shown in FIG. 4, the negative pressure is adjusted so that the reaching distance D becomes the favorable reaching distance D0, and the mist flux M is secondarily ejected to the through-holes 210, so that the mist flux M does not pass through the through-holes 210. Thereby, it is possible to suppress the surplus flux from being unintentionally attached to the upper surface component 220 on the printed board 200. Also, the negative pressure is adjusted so that the ejection angle θ becomes the favorable ejection angle θ0, and the mist flux M is secondarily ejected to the through-holes 210, so that it is possible to eject the mist flux M to only a region intended to apply the flux. Thereby, it is possible to suppress the surplus flux from being unintentionally attached to the lower surface component 230, which is not the applying target. In addition, it is possible to reduce an amount of the surplus flux to be attached to the inner surfaces of the through-holes 210 by adjusting the flow rate F.

The second nozzle 2 of the first illustrative embodiment is configured to be detachably attached to the first nozzle 1, which is the existing nozzle to be generally used for a flux spray apparatus. For this reason, when it is not necessary to weaken the flow rate and ejection pressure of the flux to be applied, for example, the flux spray apparatus 100 can be used as the flux spray apparatus 100a of the related art by detaching the second nozzle 2.

The above series of operations may be performed at a state where the negative pressure acts in the nozzle device 10 all the time and the negative pressure may be enabled to act at an ejection timing of the mist flux M. The negative pressure may be switched by manually operating the negative pressure generation device 50 or program-controlling the same with the negative pressure control device 60. Meanwhile, in the flux spray apparatus 100, the insides of the nozzle device 10 and the negative pressure pipe 30 are preferably cleaned by periodically ejecting IPA (isopropyl alcohol) or the like, so as to prevent the flux from being fixed to the inside of the nozzle device 10 and the inner surface of the negative pressure pipe 30. Also, the liquid flux L separated by the flux solution collection device 40 may be discarded or may be reused for applying the flux. When reusing the liquid flux L, the flux solution collection device 400 is connected in communication with the flux solution supply device 20 and the collected flux solution L is pneumatically transported to the flux solution supply device 20, so that the collected flux solution L is again supplied to the nozzle device 10.

### Operations and Effects of First Illustrative Embodiment

As described above, the flux spray apparatus 100 of the first illustrative embodiment includes the first nozzle 1 configured to eject the mist flux M and the second nozzle 2 provided around the first nozzle, and the second nozzle 2 is configured to suck a part of the mist flux M primarily ejected from the first nozzle 1 and to secondarily eject the remnant to the applying target. As a result, the flux spray apparatus 100 of the first illustrative embodiment has a structure simpler than the related art and can reduce the ejection amount and ejection pressure (flow strength) of the mist flux M and favorably apply the flux to the portions such as the through-holes or the components, which are difficult to be applied by the spray apparatus of the related art.

Also, according to the flux spray apparatus 100, since the negative pressure generation device 50 is configured to communicate with the second nozzle 2, it is possible to generate the suction pressure for sucking the mist flux M in the nozzle device 10 by operating the negative pressure generation device 50. Also, the negative pressure generation device 50 can adjust the suction pressure. For this reason, according to the flux spray apparatus 100, it is possible to perform the precise control of the ejection amount, which is difficult only by the control of the flow rate of the liquid flux L to be supplied from the flux solution supply device 20 to the first nozzle 1. Also, since it is possible to adjust the ejection pressure of the mist flux M, it is possible to secondarily eject the mist flux M to the applying target with the favorable reaching distance and ejection angle.

Also, the flux spray apparatus 100 is configured so that the diameter of the introduction port 212 is greater than the first ejection port 11 of the first nozzle 1 and the first ejection port 11 is located in the introduction port 212 of the second nozzle 2. Also, the flux spray apparatus 100 has the discharge ports 214 formed in the communication path 213, and is configured to discharge a part of the mist flux M from the discharge ports 214 through the communication path 213 by the suction pressure. For this reason, according to the flux spray apparatus 100, the mist flux M primarily ejected from the first nozzle 1 is substantially all introduced into the communication path 213, and a part of the mist flux M can be discharged from the discharge ports 214.

Herein, the discharge ports 214 may be arranged at any positions at which the primarily ejected mist flux M can be sucked. For example, the discharge ports may be arranged on the way of the communication path 213 but are preferably arranged in the vicinity of the first ejection port 11. In the first illustrative embodiment, the discharge ports 214 are formed in the vicinity of the first ejection port 11. For this reason, it is possible to suck the mist flux M before the mist flux completely spreads in the communication path 213 immediately after the primary ejection. As a result, it is possible to suppress the flux from being attached to the inside of the communication path 213, thereby suppressing clogging of the second nozzle 2 and improving a rate of utilization of the flux.

Also, the discharge ports 214 may have any shape capable of discharging the mist flux M from the communication path 213. For example, the discharge ports may be formed into holes opening towards the communication path 213. Meanwhile, in the first illustrative embodiment, the introduction port 212 of the second nozzle 2 and the tapered part 13 of the first nozzle contact each other, so that the notches 212a and the tapered part 13 form the discharge ports 214. Therefore, it is possible to form the discharge ports 214 in the vicinity of the first ejection port 11.

Also, according to the flux spray apparatus 100, the discharge ports 214 are provided with being equidistantly spaced over the entire circumference of the communication path 213. Also, the discharge ports 214 are formed with the space A by the second nozzle 2, and the negative pressure is enabled to act in the space A, so that a part of the mist flux M is sucked from the discharge ports 214 to the outside of the space A. That is, since the flux spray apparatus 100 can uniformly suck the mist flux M from the plurality of discharge ports 214 equidistantly spaced over the entire circumference of the communication path 213, it is possible to secondarily eject the mist flux M in a uniform spray pattern.

Meanwhile, in the first illustrative embodiment, the main body part 21 of the second nozzle 2 has the introduction portion 21 b. However, in the disclosure, the introduction portion 21b is not necessarily provided. That is, the main body part 21 may not have the introduction portion 21b, and the large-diameter portion 21c may be formed with the introduction port 212 and the notches 212a. When the main body part 21 does not have the introduction portion 21b, it is possible to reduce the ejection amount and ejection pressure (flow strength) of the mist flux M with a structure simpler than the related art.

### Second Illustrative Embodiment

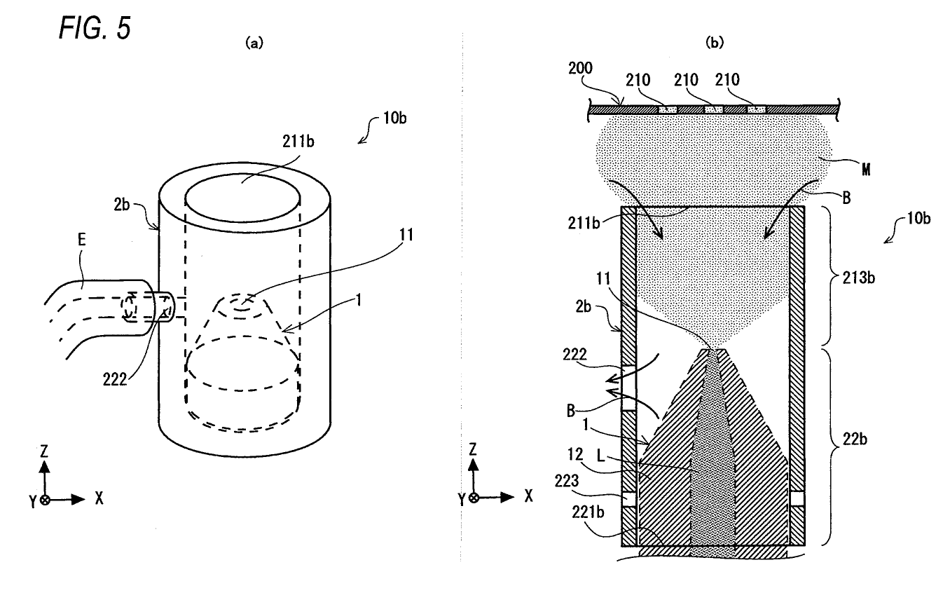

A shape of a second nozzle 2b of a flux spray apparatus 100b in accordance with a second illustrative embodiment is different from the shape of the second nozzle 2 of the flux spray apparatus 100 of the first illustrative embodiment. In the below, the flux spray apparatus 100b of the second illustrative embodiment is described with reference to FIG. 5. In the meantime, the same configurations as the flux spray apparatus 100 of the first illustrative embodiment are denoted with the same reference numerals and the detailed descriptions thereof are omitted.

FIG. 5 depicts a nozzle device 10b of the flux spray apparatus 100b. The nozzle device 10b has a second nozzle 2b having a cylindrical shape. The second nozzle 2b is substantially the same as a shape in which the main body part 21 and the collar part 23 are omitted from the second nozzle 2 of the first illustrative embodiment. That is, the second nozzle 2b is substantially the same as the shape of the housing part 22 of the second nozzle 2. Therefore, the second nozzle 2b has a cylindrical shape of which an inner diameter and an outer diameter are the same in the axial direction. The second nozzle 2b is axially divided into a passage part 213b and a housing part 22b. A tip of the passage part 213b is formed with a second opening ejection port 211b configured to eject the mist flux M to the applying target. A tip of the housing part 22b is formed with an opening 221b into which the first nozzle 1 is to be inserted. Also, the suction port 222 and the screw holes 223 are formed to penetrate side surfaces of the housing part 22b. The inner diameter of the second nozzle 2b is greater than the outer diameter of the straight cylinder part 12 of the first nozzle 1 by the fitting tolerance.

In order to mount the second nozzle 2b to the first nozzle 1 for assembling the nozzle device 10b, the second nozzle is externally fitted to the first nozzle 1 from an opening end 221 and the screws B (not shown) are tightened through the screw holes 223. In the nozzle device 10b, the second nozzle 2b does not contact the outer surface of the straight cylinder part 12 at the position at which the suction port 222 is provided. Also, the passage part 213b is located in the Z direction with respect to the ejection port 11 of the first nozzle 1.

When ejecting the mist flux M to the applying target by using the flux spray apparatus 100b of the second illustrative embodiment, it is also possible to reduce the amount and flow strength of the mist flux M to be ejected. The flux spray apparatus 100b is configured so that the negative pressure generation device 50 communicates with the inside of the nozzle device 10 via the negative pressure pipe 30 and the flux solution collection device 40. When the negative pressure generation device 50 is operated, the suction pressure acts in the nozzle device 10b so that the exterior air is introduced from the second ejection port 211b and is discharged from the suction port 222, as shown with an arrow B in (b) of FIG. 5. At this state, when the mist flux M is primarily ejected into the passage part 213b from the first nozzle 1, a part of the mist flux M is sucked and is discharged from the suction port 222 to the outside of the nozzle device 10b. The remnant of the mist flux M is rectified while passing through the passage part 213b, and is then secondarily ejected from the second ejection port 211b to the applying target.

At this time, the diameter of the second ejection port 211b and the inner diameter of the passage part 213b are greater than the diameter of the second ejection port 211 and the diameter of the communication path 213 of the second nozzle 2 of the first illustrative embodiment. Also, since the nozzle device 10b does not have the discharge ports 214, the mist flux M is sucked from the entire inside of the passage part 213b. For this reason, in the flux spray apparatus 100b, the more mist flux M is sucked, as compared to the flux spray apparatus 100 of the first illustrative embodiment. Thereby, the amount and flow strength of the mist flux M to be secondarily ejected are further reduced. As a result, the mist flux M to be secondarily ejected from the second ejection port 211b becomes a very small amount of feeble mist, like rising steam, and is then uniformly applied to the applying target. Also, since the mist flux M is secondarily ejected from the second ejection port 211b of which the diameter is greater than the second ejection port 211, the mist flux M is secondarily ejected over a wider range, as compared to the flux spray apparatus 100 of the first illustrative embodiment.

### Operations and Effects of Second Illustrative Embodiment

As described above, the flux spray apparatus 100b of the second illustrative embodiment has the second nozzle 2b having a simpler configuration than the second nozzle 2 of the first illustrative embodiment, so that it is possible to further reduce the amount and flow strength of the mist flux M to be secondarily ejected. As a result, it is possible to suppress the surplus mist flux M from passing through the through-holes 210 and from being attached to the inner surfaces of the through-holes 210. That is, according to the flux spray apparatus 100b of the second illustrative embodiment, it is possible to reduce the ejection amount and ejection pressure (flow strength) of the mist flux M with the simpler structure and to favorably apply the flux to the portions such as the through-holes or the components, which are difficult to be applied by the spray apparatus of the related art. Also, it is possible to precisely control the amount and flow strength of the mist flux M to be ejected by adjusting the suction pressure that is to be generated by the negative pressure generation device 50. Also, according to the flux spray apparatus 100b of the second illustrative embodiment, it is possible to uniformly apply the flux over the wider range, as compared to the flux spray apparatus 100 of the first illustrative embodiment. For this reason, the flux spray apparatus 100b of the second illustrative embodiment can be favorably used when applying the flux to the applying target in a short time over a wide range without limiting an applying region.

### Embodiments

In the below, a comparison test of an embodiment of the flux spray apparatus of the first illustrative embodiment and a conventional example is described. However, the disclosure is not limited to the below embodiment.

A flux spray apparatus of the embodiment corresponds to the flux spray apparatus 100 of the first illustrative embodiment. That is, a nozzle device of the embodiment has a second nozzle corresponding to the second nozzle 2 mounted to a first nozzle corresponding to the first nozzle 1 and is configured to suck a part of a flux ejected from the first nozzle by applying a negative pressure.

A flux spray apparatus of the conventional example corresponds to the flux spray apparatus 100a of the related art. That is, the flux spray apparatus is an apparatus where the second nozzle is detached from the flux spray apparatus of the embodiment.

In the comparison test, the flux reaching distances in the embodiment and the conventional example are compared. In the test, the flux reaching distances are compared when ejecting the flux with the flux spray apparatus of the conventional example and when ejecting the flux with the flux spray apparatus of the embodiment. In the conventional example, the flux reaching distance is obtained by measuring a distance from the ejection port of the first nozzle to a position that the flux reaches, and in the embodiment, the flux reaching distance is obtained by measuring a distance from the ejection port of the second nozzle to a position that the flux reaches. In the embodiment and the conventional example, the first nozzles are the same and the flow rates and ejection pressures of the flux to be ejected from the first nozzles are the same. Also, in the embodiment, the negative pressure that is enabled to act in the nozzle device is changed stepwise and the flux reaching distance is measured at each negative pressure.

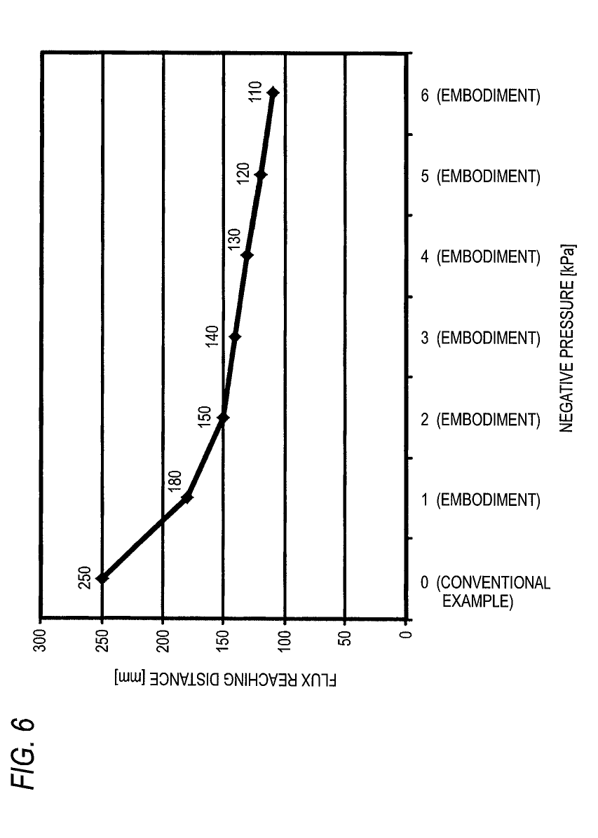

FIG. 6 is a graph depicting a result of the comparison test of the flux spray apparatuses of the embodiment and the conventional example. In the graph, a horizontal axis indicates an absolute value of the negative pressure to act in the flux spray apparatus and a vertical axis indicates the flux reaching distance. A result obtained when the negative pressure is 0 kPa is a result of the conventional example. As shown in FIG. 6, in the embodiment, as the absolute value of the negative pressure increases, the flux reaching distance becomes shorter. Also, in the embodiment, the flux reaching distance is not greater than the conventional example.

As described above, the flux spray apparatus of the embodiment has the second nozzle mounted to the first nozzle and sucks a part of the flux ejected from the first nozzle by using the negative pressure, thereby reducing the flux reaching distance, as compared to the conventional example. Also, it is possible to adjust the flux reaching distance by changing the magnitude of the negative pressure.

### Modified Embodiments

In the above illustrative embodiments, the nozzle device 10; 10b is a device in which the first nozzle 1 and the second nozzle 2; 2b, which are separate members, are coupled with each other. However, the nozzle device 10; 10b of the disclosure may be a device in which the first nozzle 1 and the second nozzle 2; 2b are integrally formed. When the first nozzle 1 and the second nozzle 2; 2b of the nozzle device 10; 10b are integrally formed, it is possible to reduce the ejection amount and ejection pressure (flow strength) of the mist flux M with a simpler structure than the related art, without increasing the number of components.

In the above illustrative embodiments, the liquid that is to be ejected with the nozzle device 10; 10b is formed into the flux and the spray apparatus is the flux spray apparatus 100; 100b. However, the disclosure is not limited thereto. The liquid that is to be sprayed with the nozzle device 10; 10b is not particularly limited. For example, a coating material such as paint can also be favorably used.

In the meantime, the above descriptions can be combined as much as possible without departing from the technical spirit of the disclosure.

What is claimed is:

1. A spray apparatus comprising:
a first nozzle configured to eject mist; and
a second nozzle provided around the first nozzle,
wherein the second nozzle is configured to suck a part of the mist ejected from the first nozzle and to eject a remnant of the mist to an ejection target.

2. The spray apparatus according to claim 1,
wherein the first nozzle has a first ejection port configured to eject the mist,
wherein the second nozzle has an introduction port including therein the first ejection port, a second ejection port configured to eject the remnant of the mist, and a communication path communicating the introduction port and the second ejection port with each other, and
wherein the communication path has a discharge port configured to suck a part of the mist thereinto.

3. The spray apparatus according to claim 2, further comprising a suction device connected to the second nozzle,
wherein the communication path has a cylindrical shape,
wherein the discharge port is comprised of a plurality of discharge ports provided at a regular interval over an entire circumference of the communication path in a circumferential direction thereof,
wherein a space is formed in the spray apparatus and around the plurality of discharge ports, and
wherein the suction device is configured to suck the part of the mist into the space from the plurality of discharge ports by generating a negative pressure for sucking the part of the mist in the space.

4. The spray apparatus according to claim 1, further comprising a suction device connected to the second nozzle,
wherein the suction device is configured to generate a negative pressure for sucking the part of the mist in the spray apparatus and is capable of adjusting the negative pressure.

5. The spray apparatus according to claim 2, wherein the discharge port is formed in the vicinity of the first ejection port.

6. The spray apparatus according to claim 2,
wherein the communication path is provided with a notch reaching the introduction port, and
wherein the discharge port is formed by the notch.

7. A method of ejecting mist by a spray apparatus, the method comprising:
ejecting the mist from a first nozzle configured to ejecting the mist, and
sucking a part of the mist ejected from the first nozzle by a second nozzle provided around the first nozzle and ejecting a remnant of the mist from the second nozzle to an ejection target.
